(19) United States
(12) Patent Application Publication
(10) Pub. No.: US 2025/0133445 A1
(43) Pub. Date: Apr. 24, 2025

(54) UPLINK RADIO RESOURCE GRANT DYNAMIC SCHEDULING

(71) Applicant: Dell Products, L.P., Round Rock, TX (US)

(72) Inventor: Ali Esswie, Calgary (CA)

(21) Appl. No.: 18/490,516

(22) Filed: Oct. 19, 2023

(51) Int. Cl. H04W 28/10; H04W 72/1268

(52) U.S. Cl. CPC H04W 28/10; H04W 72/1268

(57) ABSTRACT

A radio access network node may receive, from a core network, traffic information corresponding to an extended reality traffic flow associated with an extended reality processing unit or an end extended reality appliance. The node may transmit to the processing unit an uplink resource grant configuration indicating a sharable uplink resource usable to transmit uplink traffic to the node. The processing unit may receive uplink traffic from the appliance and may relay the uplink traffic to the node. The processing unit may determine that continued relaying of the uplink traffic may violate a criterion and may schedule sharable uplink resource(s), indicated in the uplink resource grant configuration, for use by the appliance in transmitting the uplink traffic directly to the node. The processing unit may transmit an uplink resource sharing report to the node to facilitate the node avoiding blind decoding the uplink traffic received according to the scheduled resource(s).

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a radio access network node comprising a processor, receiving, from core network equipment of a core network, a traffic flow information message comprising traffic information corresponding to a traffic flow associated with a user equipment. The traffic flow may comprise traffic associated with an extended reality session. In embodiment, the user equipment may be an extended reality processing unit and in an embodiment the user equipment may be an end extended reality appliance. The core network may comprise an extended reality server that is facilitating the extended reality session with the user equipment, wherein the user equipment is an end extended reality appliance. Based on the traffic information and a scheduling bias, the method may further comprise determining, by the radio access network node, an uplink resource grant configuration comprising at least one resource grant of at least one uplink resource usable to transmit, to the radio access network node, uplink traffic corresponding to the traffic flow. The method may further comprise facilitating, by the radio access network node, transmitting, to the user equipment, the uplink resource grant configuration and facilitating, by the radio access network node, receiving a first uplink traffic payload corresponding to the traffic flow according to the uplink resource grant configuration.

The traffic information may comprise the scheduling bias. In an embodiment, the traffic information may not comprise the scheduling bias and the method may further comprise, based on the traffic information, determining, by the radio access network node, the scheduling bias. In an embodiment, the traffic information may comprise the scheduling bias and the method may further comprise, based on the traffic information, determining, by the radio access network node, the scheduling bias and overriding by the radio access network node the bias value contained in the traffic information.

In an embodiment, the method may further comprise facilitating, by the radio access network node, receiving a second uplink traffic payload corresponding to the traffic flow, wherein the second uplink traffic payload is received before the first uplink traffic payload. The determining the scheduling bias may comprise determining a payload segmentation value corresponding to the second uplink traffic payload. The method may further comprise analyzing the payload segmentation value with respect to a payload segmentation criterion, to result in an analyzed payload segmentation value and, based on the analyzed payload segmentation value satisfying the payload segmentation criterion, increasing a baseline scheduling bias by a scheduling bias adjustment value that corresponds to the analyzed payload segmentation value.

In an embodiment, the determining the payload segmentation value may comprise determining a segmentation count of at least one packet segment, corresponding to the second uplink traffic payload, associated with violating an uplink latency criterion. The payload segmentation criterion may comprise a latency-violating segment threshold, and wherein the payload segmentation criterion is satisfied by the segmentation count exceeding the latency-violating segment threshold.

The method may further comprise facilitating, by the radio access network node, receiving second uplink traffic payload corresponding to the traffic flow, wherein the second uplink traffic payload is received before the first uplink traffic payload. The determining the scheduling bias may comprise determining a payload segmentation value corresponding to the second uplink traffic payload, analyzing the payload segmentation value with respect to a payload segmentation criterion, to result in an analyzed payload segmentation value. Based on the analyzed payload segmentation value satisfying the payload segmentation criterion, the determining the scheduling bias may comprise decreasing a baseline scheduling bias by a scheduling bias adjustment value that corresponds to the analyzed payload segmentation value. The payload segmentation criterion may be satisfied by a segmentation count, corresponding to the payload segmentation value, being less than a latency-violating segment threshold.

In an embodiment, the uplink resource grant configuration may comprise a resource sharing indication indicative of at least one sharable resource of the at least one uplink resource that is sharable, by the user equipment, to at least one end extended reality appliance with respect to which the user equipment is facilitating an extended reality uplink traffic flow. The uplink resource grant configuration may comprise sharable resource information corresponding to the at least one sharable resource. The sharable resource information may comprise at least one device identifier corresponding to at least one extended reality appliance with respect to which the user equipment is facilitating an extended reality uplink traffic flow.

The uplink resource grant configuration may comprise uplink transmission information corresponding to the at least one extended reality appliance. The uplink transmission information may comprise at least one of: an uplink modulation scheme or an uplink coding scheme.

In an embodiment, the method may further comprise facilitating, by the radio access network node, a blind decoding of the at least one sharable resource.

In an embodiment, the method may further comprise facilitating, by the radio access network node, receiving, from the user equipment, an uplink resource sharing report comprising a shared resource indication indicative of the at least one of the at least one extended reality appliance using the at least one sharable resource to transmit the extended reality uplink traffic flow. The method may further comprise facilitating, by the radio access network node, avoiding a blind decoding of the at least one sharable resource, and facilitating, by the radio access network node, a direct decoding of the at least one sharable resource based on transmission configuration information corresponding to the at least one extended reality appliance.

In another example embodiment, a radio access network node may comprise a processor configured to determine an uplink resource grant configuration comprising at least one resource grant of at least one uplink resource usable to transmit, to the radio access network node, uplink traffic corresponding to at least one extended reality appliance, wherein the uplink resource grant configuration is determined based on a scheduling bias. The processor may be further configured to transmit, to an extended reality processing unit, the uplink resource grant configuration, and to receive first uplink traffic payload according to the at least one uplink resource.

In an embodiment, the processor may be further configured to receive second uplink traffic payload corresponding to the at least one extended reality appliance, wherein the second uplink traffic payload is received before the first uplink traffic payload, and to determine a payload segmentation value corresponding to the second uplink traffic payload, for example a number of packets of the second uplink payload that are segmented. The processor may be further configured to analyze the payload segmentation value with respect to a payload segmentation criterion, to result in an analyzed payload segmentation value and to determine the scheduling bias based on the analyzed payload segmentation value satisfying the payload segmentation criterion. The scheduling bias may be determined by increasing a baseline scheduling bias by a scheduling bias adjustment value that corresponds to the analyzed payload segmentation value to result in the scheduling bias. The uplink resource grant configuration may comprise a resource sharing indication indicative of at least one sharable resource of the at least one uplink resource that is sharable, by the extended reality processing unit, to the at least one extended reality appliance with respect to which the user equipment is facilitating an extended reality session.

In yet another example embodiment, a non-transitory machine-readable medium may comprise executable instructions that, when executed by a processor of a radio access network node, facilitate performance of operations, comprising determining an uplink resource grant configuration comprising at least one resource grant of at least one sharable uplink resource usable to transmit, to the radio access network node, uplink traffic corresponding to an extended reality session associated with at least one extended reality appliance that is being facilitated by a user equipment. The operations may further comprise transmitting, to the user equipment, the uplink resource grant configuration, and receiving uplink traffic payload corresponding to the extended reality session.

In an embodiment, the operations may further comprise blindly decoding the at least one sharable resource.

In an embodiment, the operations may further comprise receiving, from the user equipment, an uplink resource sharing report comprising a shared resource indication indicative of the at least one extended reality appliance using the at least one sharable resource to transmit the uplink traffic payload, avoiding the blindly decoding of the at least one sharable resource, and decoding of the at least one sharable resource based on transmission configuration information, contained in the uplink resource sharing report, corresponding to the at least one extended reality appliance.

### BRIEF DESCRIPTION OF THE DRAWINGS

FIG. 1 illustrates wireless communication system environment.

FIG. 2 illustrates an example virtual reality appliance.

FIG. 3 illustrates an extended reality processing unit configured to perform RAN-node-related/radio-related functions.

FIG. 4 illustrates an example environment with a network node receiving traffic volume information from a core network.

FIG. 5 illustrates an example with a scheduling bias being determined locally at a network node.

FIG. 6 illustrates an example with an uplink resource grant being transmitted from a network node to an extended reality processing unit.

FIG. 7 illustrates an example downlink message that comprises uplink resource grant configuration information.

FIG. 8 illustrates example decoding behavior by a network node that is implementing dynamic uplink resource sharing.

FIG. 9 illustrates an example uplink resource sharing report.

FIG. 10 illustrates an example network node decoding a sharable uplink resource based on information contained in an uplink resource sharing report.

FIG. 11 illustrates a timing diagram of an example embodiment.

FIG. 12 illustrates a timing diagram of another example embodiment.

FIG. 13 illustrates a flow diagram of an example embodiment method.

FIG. 14 illustrates a block diagram of an example method embodiment.

FIG. 15 illustrates a block diagram of an example radio access network node embodiment.

FIG. 16 illustrates a block diagram of an example non-transitory machine-readable medium embodiment.

FIG. 17 illustrates an example computer environment.

FIG. 18 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘extended reality’ (“XR”) services. XR service may be referred to as anything reality services. XR services may comprise VR applications, which are widely adopted XR applications that provide an immersive environment which can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate. In addition, different packet traffic flows of a single XR communication session may affect an end user's experience differently. For instance, a smart glass that is streaming 180-degree high-resolution frames may use a large percentage of a broadband service's capacity for fulfilling a user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at an XR capable device is desirable. Accordingly, a user equipment device accessing XR services, or traffic flows of an XR session, may be associated with certain QoS parameter criterion/criteria to satisfy performance targets of the XR service. Measured traffic values, or metrics, may correspond to a QoS, or analyzed with respect to, parameter criterion/criteria, such as, for example, a data rate, an end-to-end latency, or a reliability.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic.

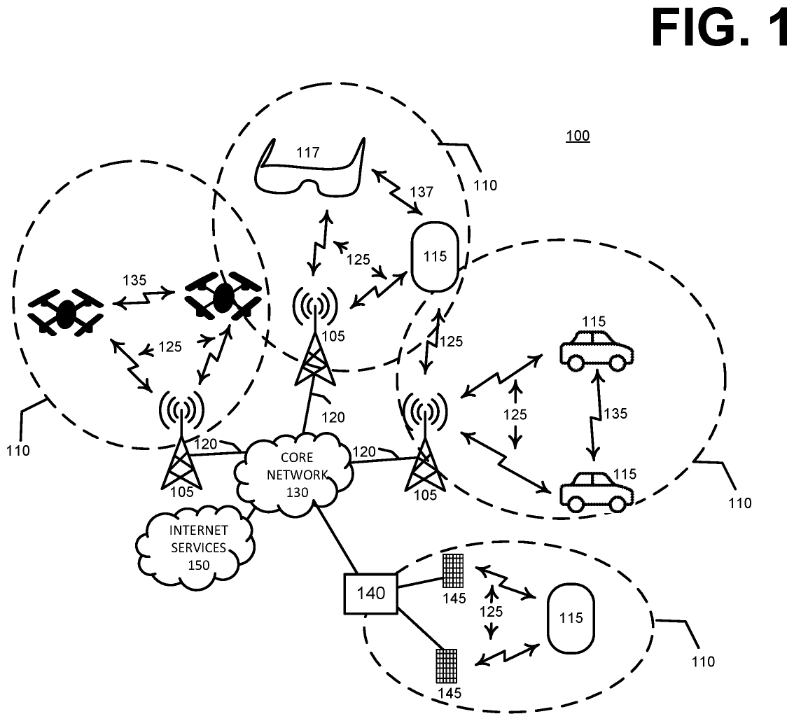

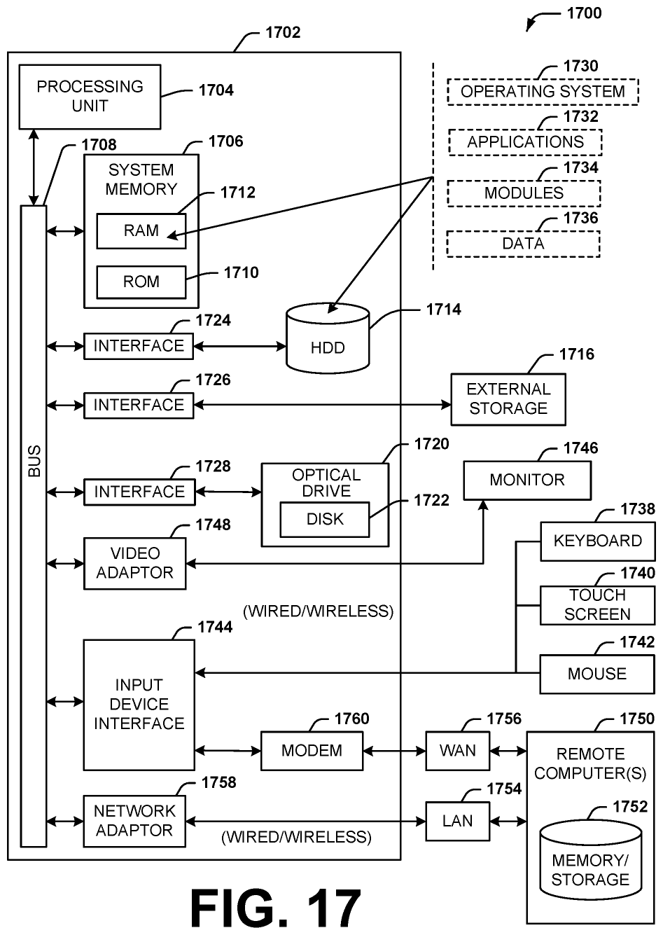

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality beadset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UB, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 17.

Continuing with discussion of FIG. 1, base stations 105 may be dispersed throughout a geographic area to form the wireless communication system 100 and may be devices in different forms or having different capabilities. Base stations 105 and UEs 115 may wirelessly communicate via one or more communication links 125. A base station 105 may be referred to as a RAN node. Each base station 105 may provide a coverage area 110 over which UEs 115 and the base station 105 may establish one or more communication links 125. Coverage area 110 may be an example of a geographic area over which a base station 105 and a. UB 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, a wireless transmit receive unit (“WTRU”), or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, an end extended reality appliance, an extended reality processing unit, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of T=I/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing, Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or more component carriers.

In some examples, a carrier may support multiple cells, and different cells may be configured according to different protocol types (e.g., MTC, narrowband IoT (NB-IoT), enhanced mobile broadband (eMBB) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication), M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations, Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A. Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

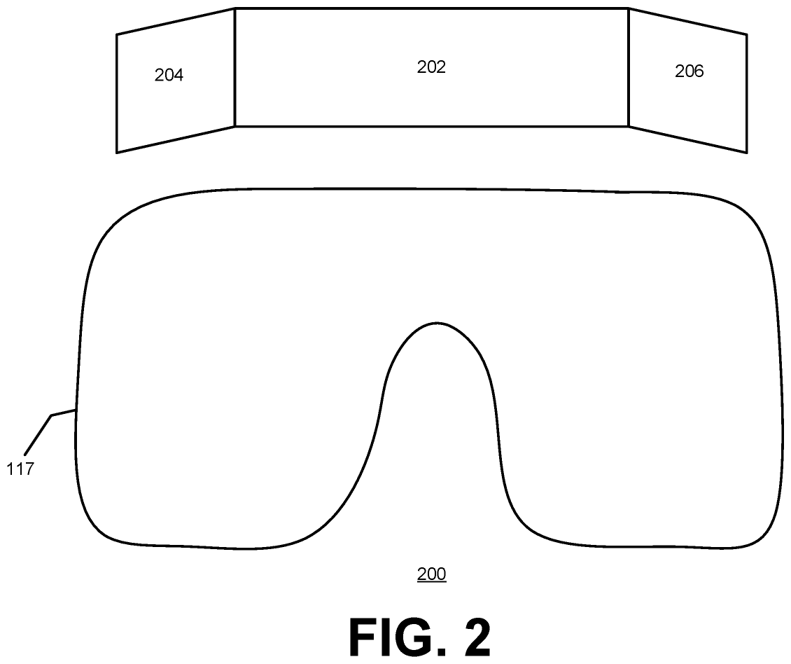

Turning now to FIG. 2, the figure illustrates a virtual reality (“VR”) application system 200. In system 200, wearable VR appliance 117 is shown from a wearer's, or viewer's, perspective. VR appliance 117 may comprise a center, or pose, visual display portion 202, a left visual display portion 204 and a right visual display portion 206, that may be used to display main visual information, left peripheral visual information, and right peripheral visual information, respectively. As shown in the figure, the portions 202, 204, and 206 are delineated by distinct lines, but it will be appreciated that hardware or software may facilitate gradual transition from main and peripheral information display.

As discussed above, different XR use cases may require different corresponding radio performance. Typically, for XR use cases but unlike for URLLC or eMBB use cases, high-capacity radio links that carry XR data traffic (e.g., data flows that comprise visual information) with stringent radio levels (e.g., latency) and reliability levels are required for a reasonable end user experience. For example, compared to a 5 Mbps URLLC link with a 1 ms radio latency budget, some XR applications require 100 Mbps links with about 2 mS allowed radio latency.

From research, several characteristics have been determined that for XR data traffic: (1) XR traffic characteristics are typically periodic with time-varying packet size and packet arrival rate; (2) XR capable devices may be more power-limited than conventional mobile handsets, (e.g., smart glasses, projection wearables, etc.) due to the limited form factor of the devices; (3) multiple data packet flows corresponding to different visual information of a given XR session are not perceived by a user as having the same impact on the end user experience.

Thus, in addition to needing XR-specific power use efficiency, smart glasses, such as wearable appliance 117, streaming 180-degree high-resolution frames require, broadband capacity for providing an optimum user experience. However, it has been determined that data corresponding to the frames that carry main, or center visual information (i.e., the pose or front direction) are the most vital for end user satisfaction, while the frames corresponding to peripheral visual information have a lesser impact on a user's experience. Therefore, accepting higher latency for less important traffic flows so that resources that would otherwise be allocated to the less important traffic flows can be used for traffic flows corresponding to more important traffic, or to devices that carry the more important traffic, may be used to optimize overall capacity and performance of a wireless communication system, such as a 5-G communication system using NR techniques, method, systems, or devices. For example, a wireless data traffic flow carrying visual information for display on center, or pose, visual display portion 202 may be prioritized higher than a wireless data traffic flow carrying visual information for left visual display portion 204 or for right visual display portion 206.

The performance of a communication network in providing an XR service may be at least partially determined according to satisfaction of a user of the XR services. Each XR-service-using user device may be associated with certain QoS metrics to satisfy the performance targets of the user's service, in terms of perceived data rate, end-to-end latency, and reliability.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

As diverse XR services, including VR, AR, and MR proliferate, radio optimization techniques to facilitate the very high network capacity that the applications require are desirable. Such requirements may be the result of increases in streaming of ultra-high-capacity video content, which may facilitate immersive XR user experiences, that may lead to an enormous amount of traffic corresponding to an XR session being delivered with an ultra-high capacity and low latency budget. Such large amounts of traffic coupled with stringent capacity and latency budget criteria may result in a degraded overall network spectral efficiency due to a RAN node supporting the stringent XR requirements only for a small number of user equipment while traffic to other user equipment may be blocked or throttled.

Due to stringent requirements corresponding to XR applications, such as, for example, capacity requirements, latency requirements, and reliability requirements, wherein improvement in one may exacerbate or degr4ade another, support of XR services via cellular communications has been deemed challenging and costly in terms of sacrificed spectral efficiency and energy consumption at RAN nodes and at XR devices. For example, to satisfy capacity and video rendering requirements of many XR applications, advanced multi-antenna system, sophisticated processing and large battery capacities may be adopted at XR end device appliances. This may increase the weight of an end XR device (e.g., an XR glass, helmet, bracelet, etc.), increase heating at the XR appliance, which may pose a safety concern due to proximity to a user's brain, and decrease aesthetics of an XR appliance.

Thus, a novel XR deployment model using one or more middle (e.g., intermediate between a RAN node and an end XR appliance) and highly capable XR processing unit(s), which may comprise similar equipment as user equipment 115 and which may be referred to herein as a user equipment, can comprise a generic XR processing device from a third party or may be a proprietary in-box XR supporting user equipment device, and may be adopted to handle various tasks that would otherwise be performed by an end XR user equipment appliance and to reduce size, weight, heating, battery consumption of an XR appliance while resulting in a more aesthetically pleasing XR appliance. An intermediate XR processing unit may relay all or part of XR traffic between an end XR appliance/device and a serving RAN node. Thus, an intermediate XR processing unit may effectively relax, or reduce, radio aspect processing burdens away from a low-capability, light, and aesthetically pleasing end XR device. Radio traffic processing burdens that may be facilitated by an intermediate XR processing unit and that may be taken over from an end XR appliance may comprise local traffic storage, processing-heavy control channel decoding, local XR video rendering, and advanced radio antenna manipulation/implementation. Thus, advanced receiver and processing capability for critical XR services may be facilitated while maintaining a light, pleasant-looking, and efficient end XR device/appliance. Moreover, an intermediate XR processing unit can further assist a serving RAN node in reducing network-side processing and signalling overhead that may limit commercial success of XR services deployment that typically require significant RAN node processing and control channel overhead.

Using conventional techniques, a RAN node either dynamically schedules uplink resources for each of multiple end XR devices (which may be proximate each other) or pre-reserves uplink resource sets for the end XR devices. This typically results in significant control channel overhead utilization due to frequent resource allocations corresponding to the multiple devices, and degraded network spectral efficiency due to pre-reservation(s) of traffic resources that may be ‘locked-up’ for use by a given XR device without the devices actually using the granted resources, in addition to the increased processing load on the RAN node. Embodiments disclosed herein facilitate uplink resource scheduling for multiple end XR devices in proximity of each other and for an intermediate XR processing unit/device to reduce signalling and processing overhead being performed by a RAN node.

In an embodiment, a user equipment may comprise an intermediate processing unit/device that facilitates signaling, traffic, and overall radio assistance to end XR devices (e.g., wearable helmets or glasses) and to a RAN node. An intermediate XR processing unit user equipment may comprise circuitry or software to facilitate long range wireless communication with a radio access network node. An end XR appliance may comprise circuitry or software to facilitate long range wireless communication with the radio access network mode. XR processing unit user equipment functionality may be implemented in a laptop computer or a smartphone. An intermediate XR processing unit may take over some radio operations, traffic processing, and battery consumption from end XR user equipment appliances, which may result in efficient end XR device/appliance design. For example, even though an end XR appliance may comprise circuitry or software that facilitates communication with a radio access network node, because an intermediate XR processing unit user equipment may assume, or take over, some functionality such as traffic processing/scheduling, traffic transmission to a radio access network node, and the like, an end XR appliance may need less processing capability and smaller battery size, which may result in a more streamlined form factor and less heat dissipation which are desirable from the perspective of a user of an end XR appliance.

Furthermore, from the perspective of a RAN node, an intermediate XR processing unit may facilitate reducing/offloading or uplink resource scheduling signaling and processing overhead. Instead of a RAN node using valuable long range wireless communication radio interface link resources (e.g., the resources are scarce or divided up among multiple user equipment) to communicate the scheduling of resources usable by a user equipment to transmit uplink traffic, which communication of scheduling may comprise communicating resource scheduling and frequent control channel information exchanges towards each of multiple end XR devices that may be proximate one another (e.g., in the same room or on the same floor of a building), the RAN node may schedule resources to a single-point (e.g., to an intermediate XR processing unit). The XR processing unit may dynamically share and distribute allocated resource (e.g., share resources allocated by the RAN node to the intermediate XR processing unit) to one or more in-proximity end XR devices, typically via (less valuable compared to long-range wireless link resources) non-long-range-wireless resources, such as, for example short-range wireless Wi-Fi, Wi-Gig, Bluetooth, sidelink, or similar communication links and resources. Thus, offloading some traffic scheduling and processing operations from a RAN node to an intermediate XR processing unit may result in a reduction of RAN node processing and signaling overhead. Conventional techniques do not facilitate dynamic resource scheduling sharing, wherein a user equipment may partially or fully dynamically share uplink resources to other user equipment.

Accordingly, embodiments disclosed herein may facilitate adaptive uplink resource sharing procedures wherein uplink resources granted to an intermediate XR processing unit user equipment, which may be referred to as a master, primary, or relay user equipment, may be dynamically shared (e.g., shared with respect to time) to other secondary user equipment devices that are proximate the primary user equipment on an on-demand basis. Using an intermediate XR processing unit to schedule uplink resources for one or more end XR appliance user equipment may be beneficial when the end XR devices generate, or correspond to, uplink traffic that is sporadic and latency-critical in nature, wherein a stringent latency budget may be violated if the end XR appliance must first request an uplink resource allocation, via uplink control channels, from a serving RAN node before the RAN node grants at least one uplink transmission opportunity.

Conventional techniques facilitate a RAN node in pre-configuring or ‘pre-booking’ multiple uplink resource sets corresponding to each of multiple end XR appliance devices to facilitate immediate transmission by the XR appliances of latency critical traffic. However, resource pre-configuration may result in low spectral efficiency corresponding to a RAN node with respect to sporadic traffic corresponding to an XR appliance due to resources that are scheduled being unused, and thus ‘wasted’.

Instead, according to embodiments disclosed herein, based on intelligent uplink traffic arrival statistics a RAN node may allocate a single uplink resource grant to an intermediate XR processing unit that is sufficient to carry uplink traffic generated by, or relayed by, the intermediate XR processing unit/device as well as potential sporadic traffic arrivals of proximate end XR devices. The intermediate XR processing unit may dynamically determine sharing and re-assigning of part of, or all of, a resource, or resources, that is/are granted to the intermediate XR processing unit by a RAN node to end XR devices. Thus, embodiments disclosed herein may facilitate avoiding, by the RAN node, configuring and scheduling uplink resources for each of multiple end XR devices and saving control channel signaling and processing overhead that would otherwise be used according to conventional techniques to schedule and communicate granting of resources to the multiple XR appliances, while still resulting in satisfaction of latency-stringent uplink traffic quality of service (“QoS”) requirements without inflicting spectral efficiency/capacity degradation that might result from uplink resource pre-reservation.

### Uplink Radio Resource Grant Sharing

Using embodiments disclosed herein, an intermediate XR processing unit/device may handle radio aspects (e.g., control channel decoding, scheduling, traffic storage, etc.) on behalf of one or more in-proximity XR end devices. Offloading the performing of tasks related to such radio aspects may facilitate a serving RAN node in scheduling a single larger uplink resource grant to the intermediate XR processing unit, which may partially or fully share resources granted in the single uplink grant to proximate end XR devices based on real-time traffic loading, thus relieving the RAN node as well as the end XR device of some processing and scheduling burden. Embodiments disclosed herein may comprise, at a RAN node, receiving, via backhaul links from one or more core network entities (e.g., a user plane function (“UPF”) or access and mobility function (“AMF”)), traffic volume information, that may include an average traffic arrival volume value, or indication, and an expected traffic volume standard deviation level/indication. The traffic volume information may be part of backhaul session establishment signaling, when an end XR appliance first attempts to establish an XR session and may be based on an identifier corresponding to the end XR appliance and a corresponding quality of service flow identifier (“QFI”) associated with a traffic flow corresponding to the end XR appliance. That is, an average traffic arrival volume and standard deviation may be determined and exchanged (via backhaul links) for each active XR device and for each uplink traffic flow corresponding thereto.

Using embodiments described herein, a serving RAN node may determine and apply a scheduling bias per each uplink flow corresponding to each of one or more end XR appliance devices based on tracked/determined violated QoS events. The RAN node may grant uplink resources, or resource sets, for a user equipment, such as an intermediate XR processing unit, which resources or resource sets may comprise resources that can be shared to other devices that are proximate the intermediate XR processing unit. The RAN node may perform decoding of uplink traffic based on having received information indicative that certain uplink resources granted to the user equipment have not been shared to another devices, such as an XR appliance, that resources have been shared to another device, or that resources have possibly been shared to another device.

The user equipment, such as an intermediate XR processing unit, may assign/share/re-assign part or all of uplink resources granted to the XR processing unit user equipment to other devices in proximity to the XR processing unit. The XR processing unit may effectively act as a master user equipment and may perform RAN node functionality with respect to the proximate/slave user equipment (e.g., end XR appliances), such that the master user equipment may grant uplink resources for use by the slave end XR appliance devices.

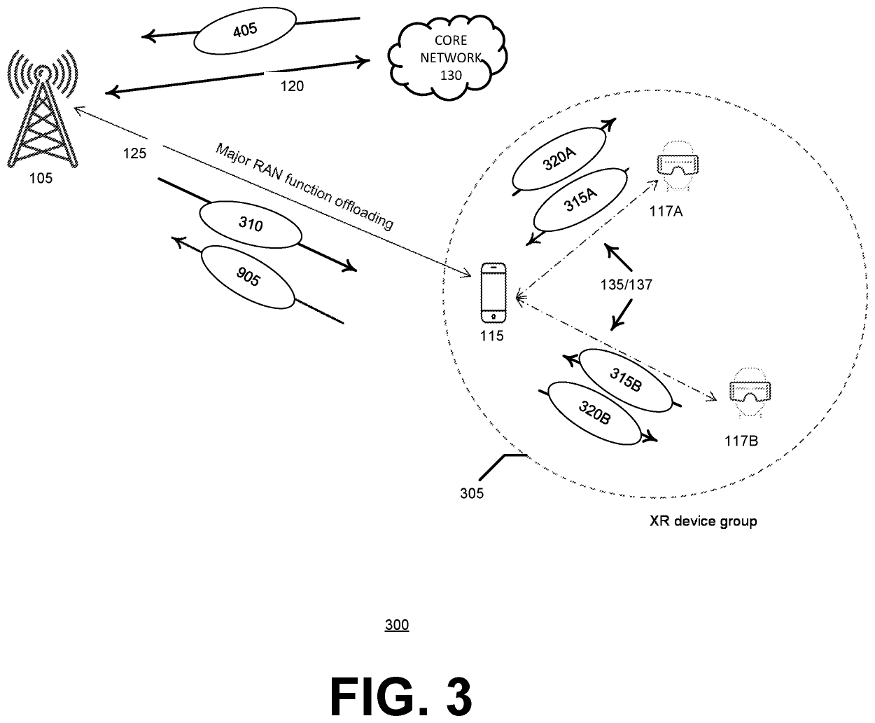

Turning now to FIG. 3, the figure illustrates an environment 300 in which radio access network node 105 may configures UE 115, which may comprise intermediate XR processing unit functionality, to perform certain RAN-node-related/radio-related functions with respect to XR end appliances 117A or 117B, or with respect to other user equipment that are part of XR user equipment group, or set, 305. RAN functionality facilitated by UE 115 may comprise scheduling uplink resources for use by different XR appliances 117. Intermediate XR processing unit 115 may receive uplink resource grant configuration 310 from RAN node 105. Intermediate XR processing unit 115 may receive uplink scheduling requests 315A and 315B from end appliances 117A and 117B, respectively.

RAN node 105 may receive traffic volume information 405, which may be referred to as a traffic flow information message, from an entity of core network 130, via backhaul links 120, from, for example, a UPF/AMF and/or an operation and management (“OEM”) center. Traffic volume information 405 may comprise a scheduling bias indication indicative of a scheduling bias corresponding to a traffic flow, or RAN node 105 itself may dynamically determine a scheduling bias level. The scheduling bias may be used as a basis, or factor, in determining, by RAN node 105, uplink resource scheduling policies to be applied to indicated average traffic volume or to respective maximums or minimums of traffic volume ranges corresponding to traffic flows. The bias may impact how fast new latency-critical uplink traffic, generated by one or more XR end appliances 117, should be transmitted to RAN node 105. For example, a scheduling bias level of a zero ‘0’ may correspond to RAN node 105 ‘assuming’ that an end XR device 117 experiences, or generates, a traffic volume as indicated in traffic volume information 405 with respect to one or more QFIs (e.g., the RAN node does not conservatively or aggressively schedule uplink resources for QFI's that are associated with a ‘0’ bias).

Based on traffic volume information 405 and a scheduling bias, serving RAN node 105 may determine a size and frequency/timing location of one or more uplink resource subsets, from within a resource set allocated for use by an intermediate XR processing unit 115, such that one or more of the determined resource subsets can be locally and dynamically shared or re-allocated by the intermediate XR processing unit to in-proximity XR end devices 117A or 117B as needed. The determined sharable resource subsets may be determined to facilitate ‘one-shot’ uplink transmission of latency critical sporadic traffic arrivals (e.g., traffic arriving at a buffer of a device) at any of the XR end devices 117 (e.g., resources may be scheduled to facilitate direct transmission of uplink traffic from an end appliance to a serving RAN node, or may reduce or eliminate the need for retransmission of latency-critical traffic to the RAN node).

RAN node 105 may transmit a downlink control information (“DCI”) message, towards intermediate XR processing unit 115, that comprises uplink resource grant configuration 310. Uplink resource grant configuration 310 may comprise one or more uplink resource sharing indications and respective sharable resource subsets, which uplink resource grant configuration may indicate certain resources as being locally sharable with active end XR appliance devices 117A or 117B. Uplink resource grant configuration 310 may comprise to-be-adopted transmission configuration information (e.g., modulation and coding schemes) corresponding to traffic to be transmitted by the intermediate XR processing unit 115 and by proximate XR end appliance devices 117A or 117B that may have offloaded uplink radio aspect functionality to the intermediate XR processing unit.

If RAN node 105 determines a scheduling bias based on received traffic volume information 405, the RAN node may track and count a number of packet segmentations, corresponding to an uplink traffic flow from an end XR appliance 117, that may have led to violating an uplink latency target associated with the uplink traffic flow corresponding to the end XR appliance device. Accordingly, on condition of a count of packet segmentations exceeding a configured criterion, such as a maximum violation number of segmentations threshold, RAN node 105 may increase a current/initial scheduling bias with a preconfigured step, biasing uplink resource scheduling to a value based on a standard deviation corresponding to the uplink traffic.

If RAN node 105 receives an uplink resource sharing report 905 from the intermediate XR processing unit 115 indicating which sharable resource subsets of an aggregate uplink resource block, granted in 310 by the RAN node to the intermediate XR processing unit, have been scheduled for use by one or more XR end devices 117A or 117B, the RAN node may avoid blind decoding of uplink traffic from the one or more end XR device(s) and decode traffic transmitted via each of the sharable resource subsets according to one or more transmission configuration(s) respectively corresponding to the one or more end XR devices to which such resource subset(s) is/are shared. Otherwise, in case of not reporting, by intermediate XR processing unit 115 to RAN node 105, an uplink resource sharing report 905, the RAN node may attempt blind decoding of uplink traffic received via the resource subsets that have been configured to be sharable among end XR appliance devices 117, using all possible transmission configurations corresponding to the set of participating end XR devices (e.g., among end XR devices for which an intermediate XR processing unit is facilitating uplink traffic scheduling). RAN node 105 would need to blindly decode sharable uplink resources if the intermediate XR processing unit 115 does not report to the RAN node which end XR devices 117 sharable resources have been shared because the RAN node would not be aware whether the sharable resources have been shared, or to which, if any, end XR appliance device(s) the sharable resources have been shared.

Intermediate XR processing unit 115 may receive inter-device uplink scheduling requests 315 from one or more participating end XR devices (e.g., end XR appliances that are part of set 305, or group, of XR appliance devices that may have offloaded one or more tasks associated with communication with a serving RAN node to intermediate processing unit 115), via short-range wireless links, for example via a sidelink interface link 135 or inter-device-specific link (e.g., Wi-Fi) 137. Uplink scheduling requests 315 received from an end XR appliance 117 may indicate a current size of buffered, latency-stringent uplink traffic at the transmitting end XR device.

Accordingly, based on uplink resource grant configuration 310 received from RAN node 105 and based on one or more received inter-device scheduling request(s) 315 received from one or more end XR appliance(s) 117, intermediate XR processing unit 115 may determine a minimum uplink resource size that may facilitate one-shot transmission of uplink traffic buffered at the end XR device(s) directly to RAN node 105. Intermediate XR processing unit 115 may then select one or more uplink resource subsets, configured or granted via configuration 310, as being sharable to other devices in proximity to the intermediate XR processing unit, to satisfy the determined minimum resource size.

Intermediate XR processing unit 115 may transmit an uplink scheduling/sharing resource grant indication 320 towards requesting one or more end XR appliance(s) 117 that may have transmitted one or more requests 315 to the intermediate XR processing unit. Resource grant indication 320 may comprise one or more indication(s) indicative of one or more sharable resources, or sharable resource sets, that intermediate XR processing unit 115 has scheduled for use by the one or more end XR appliance(s) 117. If activated, or configured, by serving RAN node 105 to generate and transmit an uplink resource sharing report, intermediate XR processing unit 115 may compile and transmit uplink resource sharing report 905, towards the serving RAN node. Uplink resource sharing report 905 may comprise one or more indications indicative of shared uplink resources and end XR device identifiers corresponding to end XR appliances 117 to which sharable resources have been shared.

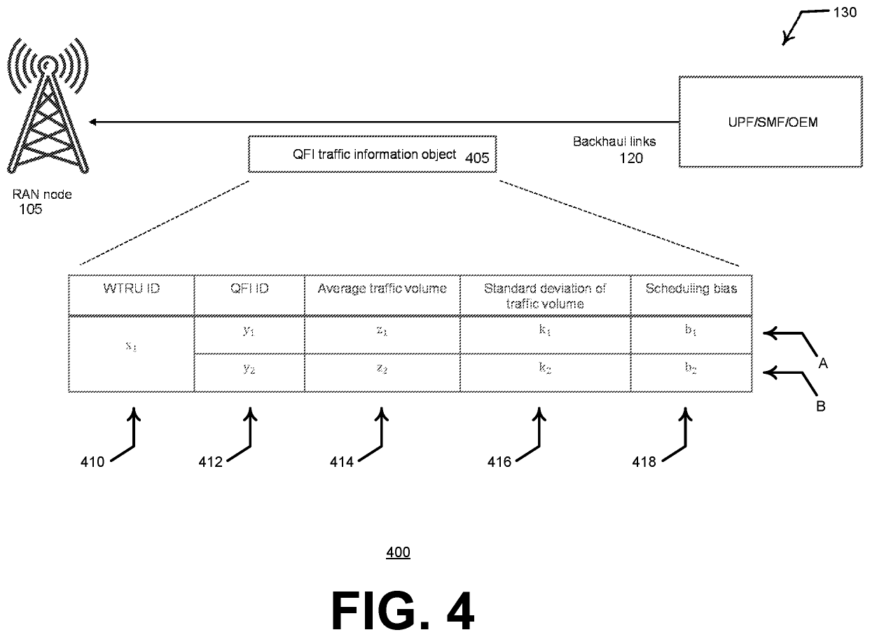

Turning now to FIG. 4, the figure illustrates an example environment 400. In the embodiment shown in FIG. 4, RAN node 105 may receive per-QFI traffic volume information 405, from a component of core network 130 (e.g., from a UPF, SMF, AMF, or OEM).

Information 405 may comprise information elements such as a device identifier field 410 that may comprise a device identifier corresponding to an end XR appliance that may have a currently established traffic session with RAN 105 or with a component of core network 130.

Information 405 may comprise one or more QFI identifier(s) in QFI identifier field(s) 412, which may comprise one or more uplink QFI with which traffic arrival volume information is associated. Information 405 may comprise one or more average traffic volume field(s) 414 that may comprise indications indicative of average expected traffic arrival volume corresponding to associated uplink QFI(s) 412 for each active device indicated in field 410. Information 405 may comprise a determined standard deviation value field 416 that may comprise a standard deviation value that may correspond to expected traffic volume associated with traffic flows that may be identified in respective QFI field(s) 412. A standard deviation value may be indicative of a standard deviation of traffic volume of a corresponding uplink traffic flow. A standard deviation value, or standard deviations values, in one or more fields 416 may facilitate RAN node 105 in determining an uplink traffic volume variance range corresponding to a traffic flow associated with a corresponding QFI in a respective field 412. Thus, for a QFI indicated in field 412B, an uplink traffic volume variance range may span from a standard deviation k₂ in filed 416B less than an average traffic volume value z₂ in field 414B to a standard deviation k₂ higher than the average traffic volume z₂.

Information 405 may comprise a scheduling bias field 418 comprising a level or indication, that may fall in a range from −1 to +1, for example. An example may comprise one of values {“−1”, “0”, “1”} to bias uplink resource scheduling at the RAN node. For example, a scheduling bias of b₂=−1 in field 418B may indicate to RAN 105 that an available traffic arrival volume generated by an end XR appliance associated with uplink QFI y₂ may be the indicated average traffic volume z₂ in field 414B minus the standard deviation k₂ in field 416B, (e.g., indicative to the RAN that uplink traffic generated by XR appliance having identifier x1 in field 410 may tend to have a volume near the low end of a traffic volume range for QFI y₂). On the other hand, a scheduling bias of b₂=+1 in field 418B may indicate to RAN 105 that an available traffic arrival volume generated by an end XR appliance associated with uplink QFI y₂ may be the indicated average traffic volume z₂ in field 414B plus the standard deviation k₂ in field 416B, thus indicating that traffic volume corresponding to QFI y₂ indicated in field 412B may be near the high end of a range. A scheduling bias of b₂=0 in field 418B may indicate to RAN node 105 that an available traffic arrival volume generated by an end XR appliance associated with uplink QFI y₂ may be the average traffic volume z₂ indicated in field 414B.

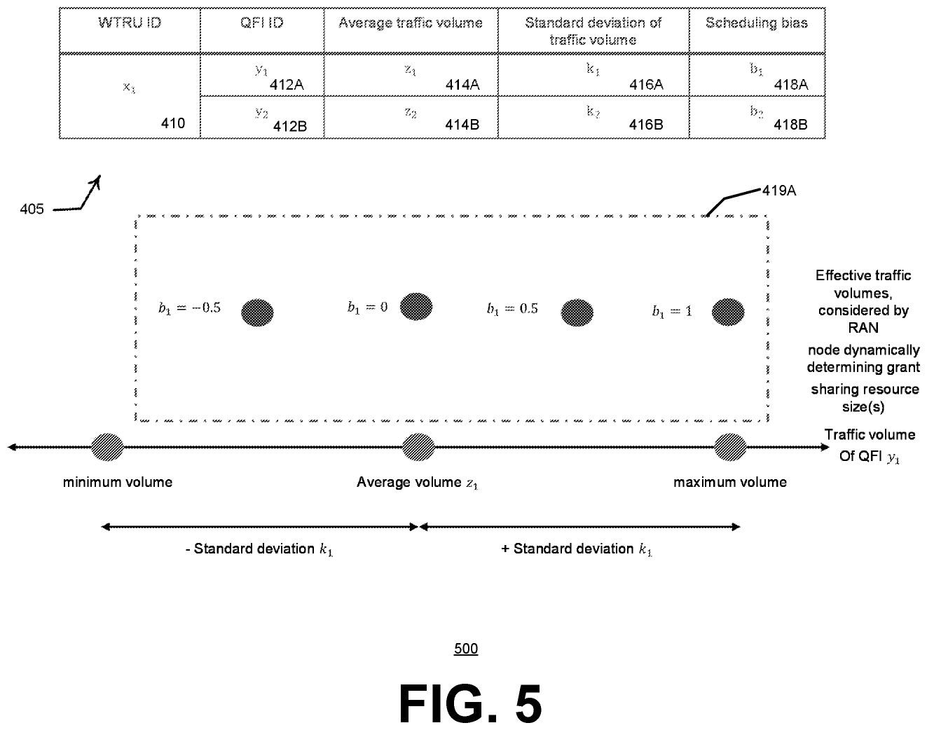

FIG. 5 illustrates an embodiment wherein a scheduling bias may be calculated and determined locally at the RAN node instead of the bias value being received in field 418 of information 405. A bias being calculated by a RAN node may lead to more efficient scheduling of uplink resources that is geared towards real-time traffic generated at end XR devices. Thus, a RAN node may adopt and apply an initial and unoptimized scheduling bias for each uplink QFI of corresponding to an XR end appliance. The RAN node may track and count a number of received packet/payload segmentations, corresponding to an uplink QFI, that lead to violating a latency QoS target associated with the QFI. On condition of the determined packet segmentation number/count exceeding a predefined maximum threshold, or on condition of the determined packet segmentation number/count decreasing during a configured segmentation determination period, the RAN node may increase a current scheduling bias by a configured bias increment (e.g., in the example shown in FIG. 5 the bias increment is 0.5). Thus, determining by the RAN node to increase a bias may result in the RAN node granting more sharable uplink resources based on the RAN having determined a likelihood of an increased volume of uplink traffic generated by the XR end application (e.g., more traffic arriving in a buffer of the XR appliance). On the other hand, on condition of the RAN node determining a number of packet segmentations that is below a configured segmentation threshold, or a downward trend of packet segmentation counts during a configured segmentation determination period, the RAN node may reduce a current scheduling bias by a configured increment such that subsequent uplink resource scheduling is determined based on an expectation of lower/smaller traffic volumes corresponding to the uplink QFI. In an embodiment, a RAN node may determine a bias increment size to correspond to a maximum traffic volume or a minimum traffic volume based on a standard deviation corresponding to the QFI as indicated in information 405.

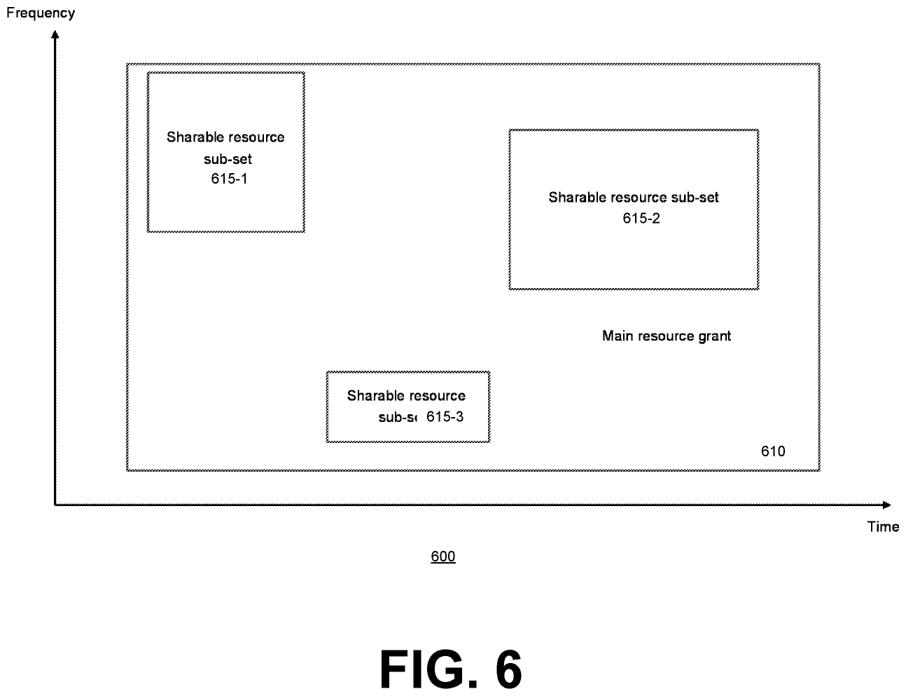

As shown in FIG. 6, uplink resource grant 610 from a RAN node towards an intermediate XR processing unit is depicted, showing resource subsets 615-1, 615-2, and 615-3 that the RAN node has deemed as sharable to other user equipment that are proximate to the intermediate XR processing unit user equipment.

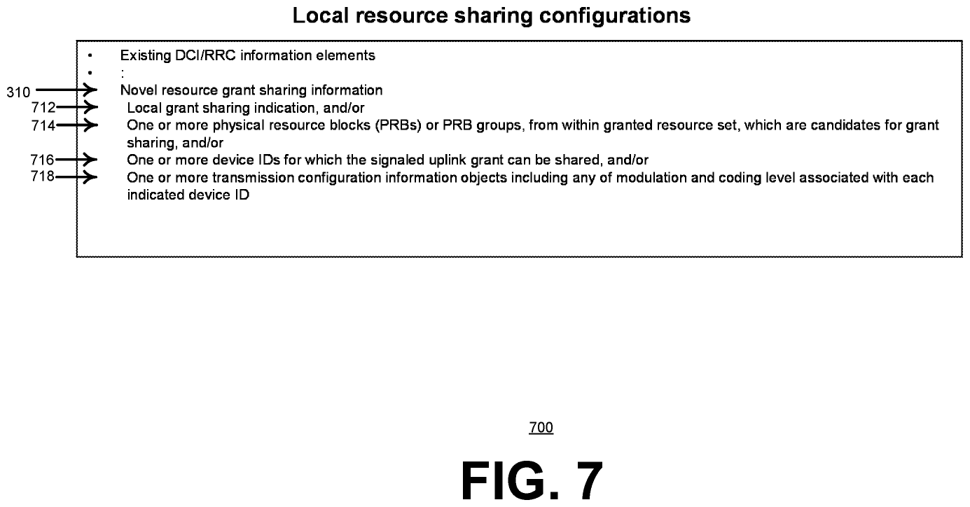

Turning now to FIG. 7, the figure illustrates a example downlink message 700 that may comprise uplink resource grant configuration 310, as described in reference to FIG. 3. Configuration 310 may be transmitted from a RAN node to an intermediate XR processing unit user equipment and may comprise information elements as part of either downlink DCI or RRC message signaling, and may include an indication 712 indicative that local uplink grant sharing is activated. Configuration 310 may comprise one or more resource subset information indication(s) 714 (e.g., timing, frequency or information indication(s)) corresponding to resources, for example resources 615 shown in FIG. 6, that the RAN node has deemed as sharable by the intermediate XR processing unit, as needed, to other user equipment, such as end XR appliance devices. Configuration 310 may comprise one or more device identifier fields 716 comprising identifiers corresponding to end XR appliance devices to which sharable uplink resource subsets indicated in field 714 can be shared in an on-demand manner. Configuration 310 may comprise one or more transmission configuration information objects/fields 718 that may include uplink modulation and coding schemes corresponding to end XR devices identified in field 716.

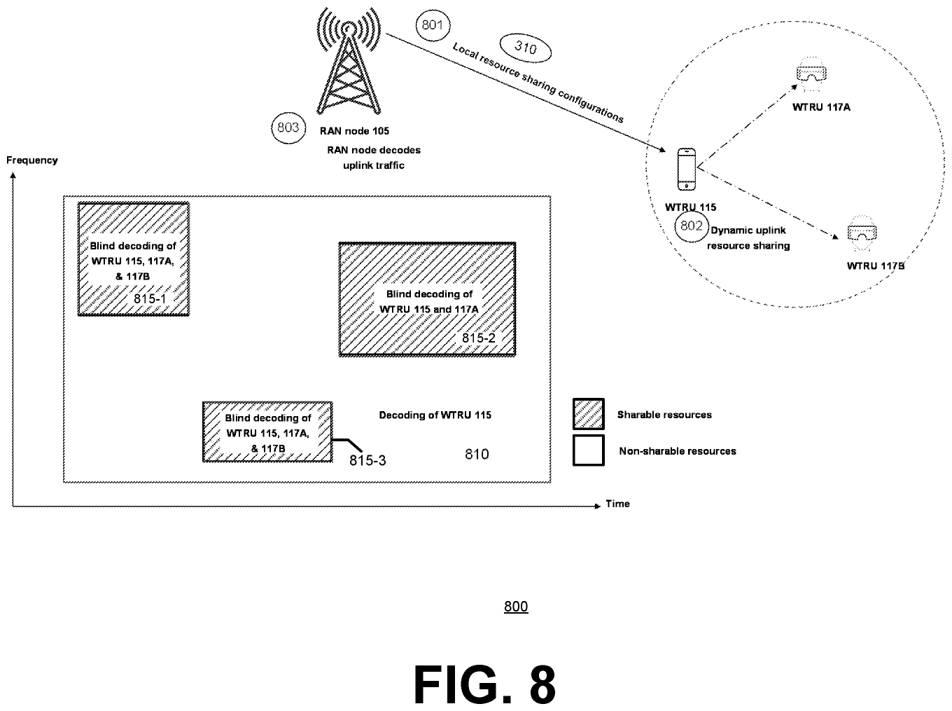

Turning now to FIG. 8, the figure illustrates example novel decoding behavior of RAN node 105 that may be implementing dynamic uplink grant sharing as disclosed herein. Radio access network node 105 may transmit configuration 310 to intermediate XR processing unit 115 at act 801. At act 802, intermediate XR processing unit 115 may schedule shareable uplink resources 815 to one or more end XR appliances 117. At act 803, RAN node 105 may directly decode uplink traffic received via non-shareable resources 810 from intermediate XR processing unit 115 using transmission configuration information corresponding to the intermediate XR processing unit since resources 810 are not deemed by RAN node 105 as sharable to proximate and XR appliances 117. However, RAN node 105 may blindly decode traffic received via sharable resources 815-1, 815-2, and 815-3, using all or a subset of all of transmission configurations corresponding to XR end devices 117 with which one or more of resource subsets 815 can be shared by processing unit 115. RAN node 105 may be blindly determining whether a certain sharable resource subset is actually shared to an XR end device 117 or not depending on which transmission configuration resulted in a successful decoding attempt. For example, RAN node 105 may blindly decode traffic received via sharable resources 815-1 using a transmission configuration corresponding to end XR device 117A and a transmission configuration corresponding to device 117B. If the transmission configuration corresponding to XR appliance 117A resulted in a successful decoding but use of a transmission configuration corresponding to appliance 117B did not, the RAN is aware that resource set 815-1 has been shared by intermediate XR processing unit 115 with appliance 117A but not with appliance 117B.

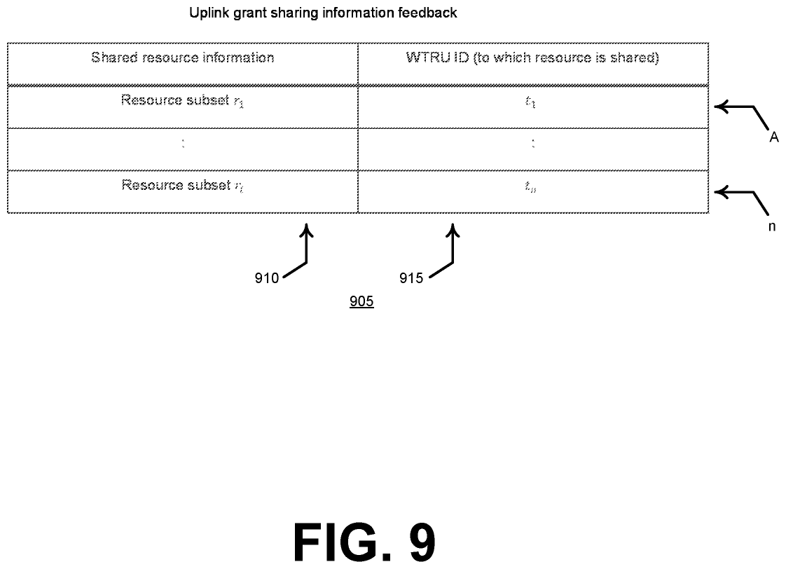

However, in an embodiment, RAN node 105 may configure intermediate XR processing unit 115 to dynamically report a shared status of configured sharable resource subsets. Thus, as shown in FIG. 9, intermediate XR processing unit 115 may periodically, or on an on-demand basis, compile a report 905 to report back to serving RAN node 105, an uplink resource sharing report, indicating which uplink sharable resource sets or resource information have been actually shared to which secondary XR end device(s). Report 905 may comprise a resource subset information field 910 and an XR appliance device identifier field 915. Field 915 may comprise one or more identifiers corresponding to one or more end XR appliances with which respective resources indicated in field 910 have been shared.

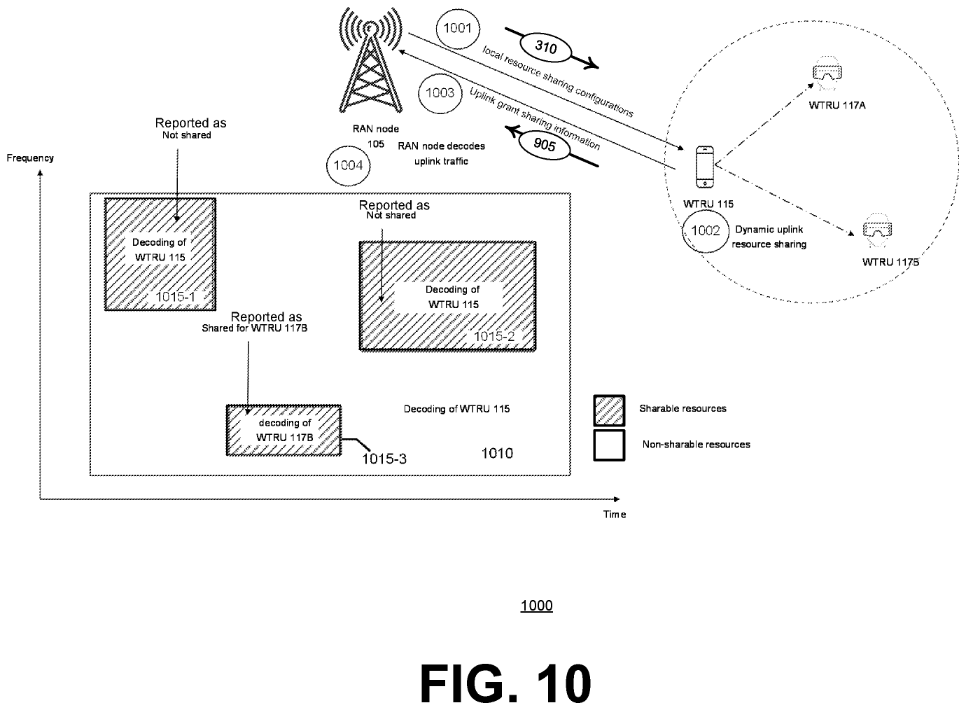

Accordingly, using an embodiment shown in FIG. 10, a reporting procedure used in environment 1000 to report uplink resource sharing information (e.g., as shown in FIG. 9) may facilitate RAN node 105 becoming aware of which sharable uplink resource subset(s) is/are shared to which end XR device(s) 117, and accordingly altering decoding behavior. For example, at act 1001, radio access network node 105 may transmit to intermediate XR processing unit 115 configuration 310. At act 1002, intermediate XR processing unit 115 may schedule resources deemed as shareable in configuration 310 with one or more of end XR appliance devices 117. At act 1003, intermediate XR processing unit 115 may transmit a report 905 to RAN node 105 such that the RAN node becomes aware that a sharable resource subset has been shared to a certain one or more end XR appliance(s) 117. Thus, instead of blindly decoding a shareable resource using transmission configuration information corresponding to more than one XR appliance device 117 and transmission configuration information corresponding to intermediate XR processing unit 115, based on information contained in report 905, RAN node 105 may directly decode traffic received via a resource subset indicated in report 905 as being shared with one or more identified and eggs are appliance devices using respective transmission configuration information corresponding to the identified/reported one or more end XR appliances. For example, as shown in FIG. 10, report 905 may comprise an indication that resource subset 1015-1 has not been shared with an end appliance 117, that resource subset 1015-2 has not been shared with an end appliance 117, and that resource subset 1015-3 has been shared with end XR appliance 117B. Thus, RAN node 105 may decode resources 1010, 1015-1, and 1015-2 using transmission configure information corresponding to intermediate XR processing unit 115 without blindly decoding the resources. RAN node 105 may decode resources 1015-3, based on information contained in report 905, using transmission configuration information corresponding to end appliance 117B without blindly decoding resources 1015-3, which blind decoding attempt would also comprise attempting to use transmission configuration information corresponding to end appliance 117A. Thus, report 905 may facilitate radio access network node 105 avoiding blind decoding of shareable resources 1015 based on information contained in the report that intermediate XR processing unit 115 has actually shared resources 1015-3 with end XR appliance 117B.

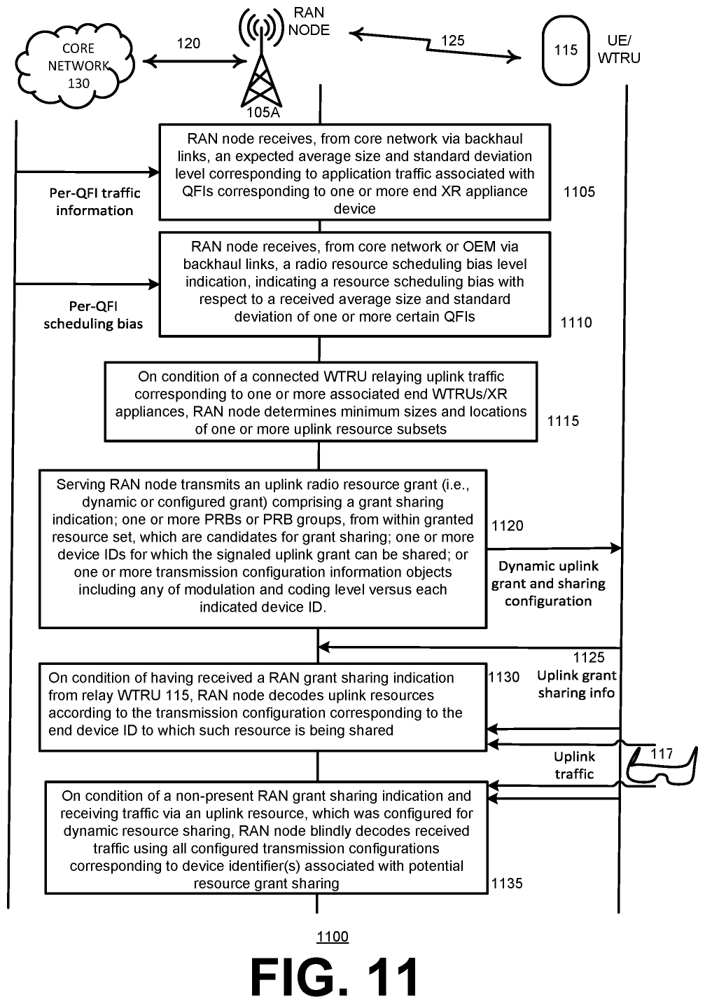

Turning now to FIG. 11, the figure illustrates a timing diagram of an example embodiment method 1100. At act 1105, RAN node 105 may receive, from core network 130 via backhaul links 120, a traffic flow information message comprising traffic information corresponding to a traffic flow associated with user equipment 115. The traffic information may comprise an expected average size and standard deviation level corresponding to extended reality traffic associated with an extended reality appliance, such as an appliance 117 described in reference to FIG. 2 that may be referred to as an end XR device or an end XR appliance. The traffic may be generated by, or directed to, an extended reality application executing on the XR end appliance. The traffic information may comprise information associated with each of one or more QoS flow indication (“QFI”) identifiers corresponding to one or more XR traffic flows associated with the XR end appliance.

At act 1110, RAN node 105 may receive, from core network or OEM, via backhaul links 120, a radio resource scheduling bias level indication, indicating a resource scheduling bias with respect to the received average size and standard deviation of one or more QFIs (e.g., a ‘0’ scheduling bias indication may imply that RAN node 105 is to schedule uplink resources based on indicated average traffic size per QFI, per end WTRU/XR appliance 117). In an embodiment, RAN 105 may determine the bias if a bias value is not included in the traffic information received at act 1105. In an embodiment, RAN 105 may determine a bias and override a bias value contained in the traffic information received at act 1105. At act 1115, on condition of connected end XR processing unit 115 facilitating relaying of uplink traffic corresponding to one or more associated end XR appliances/WTRUs 117, RAN node 105 may determine minimum sizes and locations, (e.g., locations with respect to a frequency and time map as shown in FIG. 6) of uplink resources or resource sets/subsets. The determined sizes and locations of the resources may be determined as resources, or as resource subsets of, a block of resources granted in an uplink resource grant configuration to a XR processing unit 115, that can be dynamically shared to the end XR appliances/WTRUs for use thereby to facilitate direct transmission of uplink traffic to RAN 105 instead of traffic being relayed by the XR processing unit. Such direct, un-relayed transmission of uplink traffic may be referred to as ‘one-shot’ uplink transmission (e.g., no intermediate processing or forwarding by XR processing unit 115). XR processing unit 115 may be relaying uplink traffic generated at an end XR appliance 117, but if the XR processing unit determines that a latency criterion, or latency budget, corresponding to the uplink traffic is about to violated, the XR processing unit may schedule uplink resources for use by the end XR appliance to transmit the latency-critical traffic directly to RAN 105. Thus, traffic corresponding to an XR appliance 117 that intermediate XR processing unit 115 may have been relaying to RAN 105 for the XR appliance when a corresponding latency budget was not in danger of being violated may cause, resources, that may be sharable resources, to be scheduled for use by the end XR appliance.

At act 1120, RAN node 105 may transmit an uplink resource grant configuration. The uplink resource grant configuration may comprise one or more information elements, and may be part of a DCI message or a MAC CE message. The information elements contained in an uplink resource grant configuration transmitted at act 1120 may comprise a grant sharing indication, indicative of one or more physical resource blocks (“PRB”) or PRB groups, that may be subsets of a resource set granted to XR processing unit 115, that may be sharable (e.g., that may be usable by XR processing unit 115 or one or more end XR appliances 117), or one or more device identifiers corresponding to XR processing unit or XR appliances that may use the sharable resource(s), or resource(s) set. The information elements contained in the uplink resource grant configuration may comprise one or more transmission configuration information objects, including modulation and coding level, associated with the indicated device identifiers.

In an embodiment, at act 1125 RAN 105 may receive a sharing indication, which may be referred to as an uplink resource sharing report, from relay WTRU/XR processing unit 115. On condition of having received at act 1125 an uplink resource sharing report, at act 1130 RAN node 105 may decode shareable uplink resources according to transmission configuration information corresponding to end device identifiers (corresponding to end devices 117 or XR processing unit 115) for which such resource(s) is/are being shared as indicated in the uplink resource sharing report. On condition of a uplink resource sharing report not having been received by RAN 105 from XR processing unit 115, and on condition of receiving traffic via a sharable uplink resource that was configured, via the uplink resource grant configuration transmitted at act 1120, RAN node 105 may at act 1135 blindly decode traffic received via the sharable uplink resource using all configured transmission configurations associated with all of the of the device identifiers in the uplink resource grant configuration.

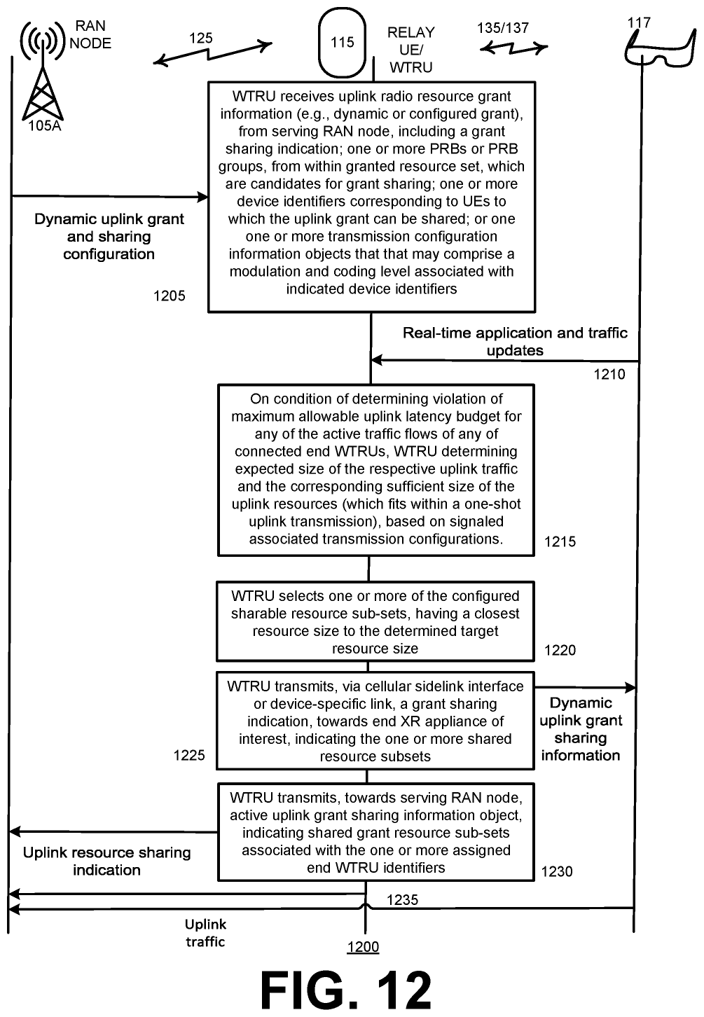

Turning now to FIG. 12, the figure illustrates a timing diagram of an example embodiment method 1200. At act 1205, XR processing unit/WTRU 115, which may facilitate relaying bidirectional traffic towards or from multiple end XR appliances/WTRUs 117, may receive an uplink radio resource grant (e.g., a dynamic or a configured grant), which may be referred to as an uplink resource grant configuration, from serving RAN node 105. The uplink resource grant configuration may comprise one or more information elements and may be part of a DCI message or a MAC CE message. The information elements contained in an uplink resource grant configuration transmitted at act 1205 may comprise a grant sharing indication, indicative of one or more PRBs or PRB groups, that may be subsets of a resource set granted to XR processing unit 115, that may be sharable (e.g., that may be usable by XR processing unit 115 or one or more end XR appliances 117), or one or more device identifiers corresponding to XR processing unit or XR appliances that may use the sharable resource(s), or resource(s) set. The information elements contained in the uplink resource grant configuration may comprise one or more transmission configuration information objects, including modulation and coding level, associated with the indicated device identifiers.

On condition of determining that uplink traffic received at act 1210 from XR end appliance 117 may violate an uplink criterion, for example a maximum allowable uplink latency budget associated with the traffic, at act 1215 XR processing unit/WTRU 115 may determine an expected size of the uplink traffic and uplink resources sufficient to accommodate the uplink traffic in being directly transmitted by the XR end appliance to RAN 105. The resources determined at act 1215 may be resources that are a set, or subset, of resources configured, or indicated, as being sharable in the configuration received at act 1205.

At act 1220, XR processing unit/WTRU 115 may select one or more of the configured sharable resource subsets having the smallest resource size (e.g., with respect to frequency and time) that is still large enough to accommodate the expected/target traffic size of the traffic as determined at act 1215. At act 1225, XR processing unit/WTRU 115 may transmit to end XR appliance 117, for example via a cellular sidelink interface or device-specific links such as Wi-Fi, Wi-Gig, or Bluetooth, a grant sharing indication, indicating one or more shared resource subsets that the end XR appliance may use to transmit the uplink traffic directly to RAN 105. In an embodiment, at act 1230, XR processing unit/WTRU 115 may transmit, towards serving RAN node 105, an active uplink grant sharing information object, which may be referred to as an uplink resource sharing report, indicating the shared grant resource(s), or resource(s) sub-set(s) and the identifier of end XR appliance 117 with which the sharable resources were shared via the uplink resource grant configuration transmitted at act 1205. At act 1235, end XR appliance 117 or intermediate XR processing unit 115 may transmit uplink traffic to radio access network node 105 according to resource scheduling information indicated at act 1225.

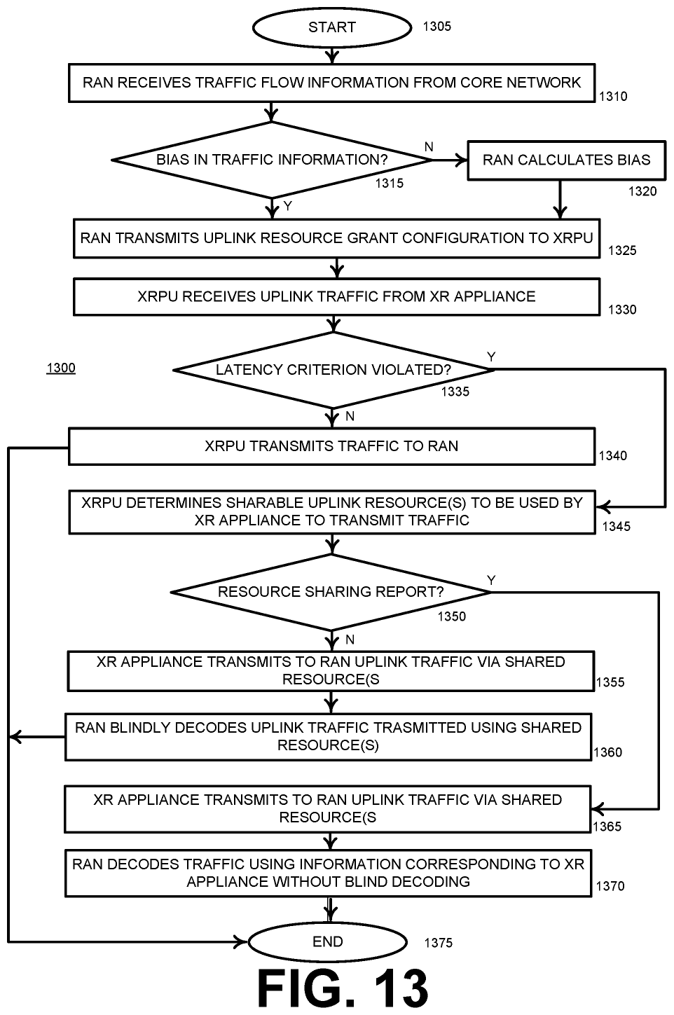

Turning now to FIG. 13, the figure illustrates a flow diagram of an example embodiment 1300. Method 1300 begins at act 1305. At act 1310, a radio access network node may receive traffic flow information from a core network component. The traffic flow information may be contained in a traffic flow information message and may contain traffic flow information associated with user equipment, such as an XR processing unit or an end XR appliance, upon which may be executing an XR application and which may be processing one or more traffic flows associated with the XR session. The XR processing unit may be facilitating, or may be configured to facilitate, uplink transmission of traffic associated with the XR session to the radio access network node. If the traffic flow information message comprises a bias value method 1300 may advance to act 1325. If the traffic flow information message received at act 1310 does not comprise a bias value corresponding to traffic that may be associated with the XR session, the radio access network node may at act 1320 calculate a bias value corresponding to the XR traffic before method 1300 advances to act 1325. At act 1325, the radio access network node may transmit an uplink resource grant configuration to the XR processing unit. At act 1330, the XR processing unit may receive uplink traffic from an end XR appliance.

At act 1335, the XR processing unit may determine whether a latency criterion, or other traffic criterion, has been violated, or is likely to be violated if traffic associated with a traffic flow corresponding to the traffic that was received at act 1330 is transmitted to the radio access network node by the XR processing unit. If a determination made at act 1335 is that continued transmission of traffic, by the XR processing unit to the radio access network node, corresponding to the traffic flow for which traffic was received at act 1330 is not likely to violate a latency or other traffic criterion, the XR processing unit may continue to transmit traffic corresponding to the traffic flow to the radio access network node. Method 1300 advances to act 1375 and ends.

Returning to description of act 1335, if the XR processing unit determines that the latency criterion, or other traffic criterion is likely to be violated by continued transmission, by the XR processing unit to the radio access network node, of traffic associated with the traffic received at act 1330, method 1300 may advance to act 1345. At act 1345, the XR processing unit may determine a shareable uplink resource, or shareable uplink resources, that may be usable by the end XR appliance to transmit traffic packets associated with the traffic received at 1330 directly from the end XR appliance to the radio access network node, and transmit to the end XR appliance an indication of the determined resource(s) via a grant sharing indication indicative of the one or more shared resource(s)/resource subset(s) that the end XR appliance may use to transmit the uplink traffic directly to the radio access network node. The resource, or resources, determined at act 1345, may be usable by, or shareable to, other end XR appliances in addition to the and XR appliance to which the traffic received at act 1330 may be associated. At act 1350, the XR processing unit may transmit an uplink resource sharing report to the radio access network node indicative of the shareable resources that were determined at act 1345.

If the XR processing unit does not transmit an uplink resource sharing report to the radio access network node at act 1350, at act 1355 the end XR appliance may transmit traffic associated with the traffic received at act 1330 to the radio access network node directly via the shareable resource, or resources, indicated to the end XR appliance at act 1345. At act 1360 the radio access network node may blindly decode the shareable resource, or resources, because the XR processing unit did not apprise the radio access network node, via an uplink resource sharing report, that the end XR appliance would be using the shareable resource to transmit uplink traffic. Method 1300 advances to act 1375 and ends.

Returning to description of act 1350, if the XR processing unit transmits an uplink resource sharing report to the radio access network node that indicates that the end XR appliance will be using the shareable resource or resources determined that act 1345, the end XR appliance may at act 1365 transmit uplink traffic associated with the traffic received at act 1330 to the radio access network node via the shared resource, or resources, determined at act 1345. At act 1370, the radio access network node may decode the resource, or resources indicated in the uplink resource sharing report using information corresponding to the end XR appliance that may have been included in the uplink resource grant configuration that was transmitted to the XR processing unit at act 1325. Method 1300 advances to act 1375 and ends.

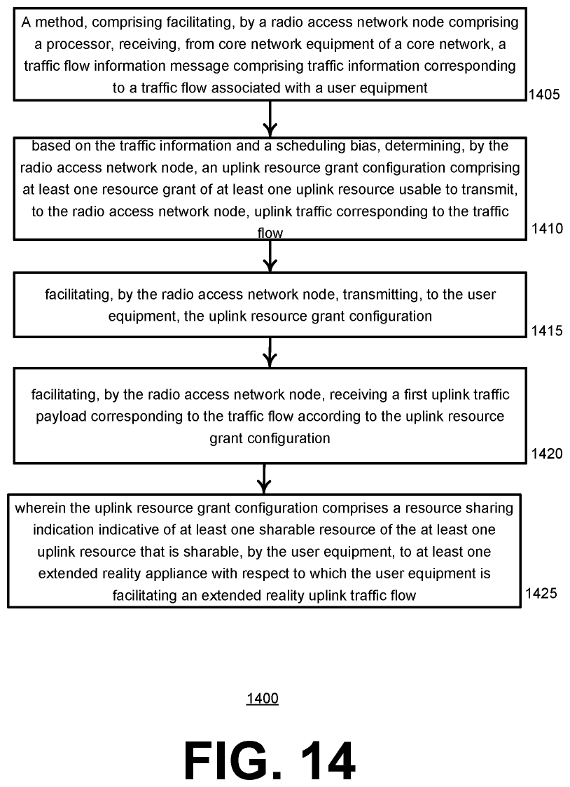

Turning now to FIG. 14, the figure illustrates an example embodiment method 1400 comprising at block 1405 facilitating, by a radio access network node comprising a processor, receiving, from core network equipment of a core network, a traffic flow information message comprising traffic information corresponding to a traffic flow associated with a user equipment; at block 1410 based on the traffic information and a scheduling bias, determining, by the radio access network node, an uplink resource grant configuration comprising at least one resource grant of at least one uplink resource usable to transmit, to the radio access network node, uplink traffic corresponding to the traffic flow; at block 1415 facilitating, by the radio access network node, transmitting, to the user equipment, the uplink resource grant configuration; at 1420 facilitating, by the radio access network node, receiving a first uplink traffic payload corresponding to the traffic flow according to the uplink resource grant configuration; and at block 1425 wherein the uplink resource grant configuration comprises a resource sharing indication indicative of at least one sharable resource of the at least one uplink resource that is sharable, by the user equipment, to at least one extended reality appliance with respect to which the user equipment is facilitating an extended reality uplink traffic flow.

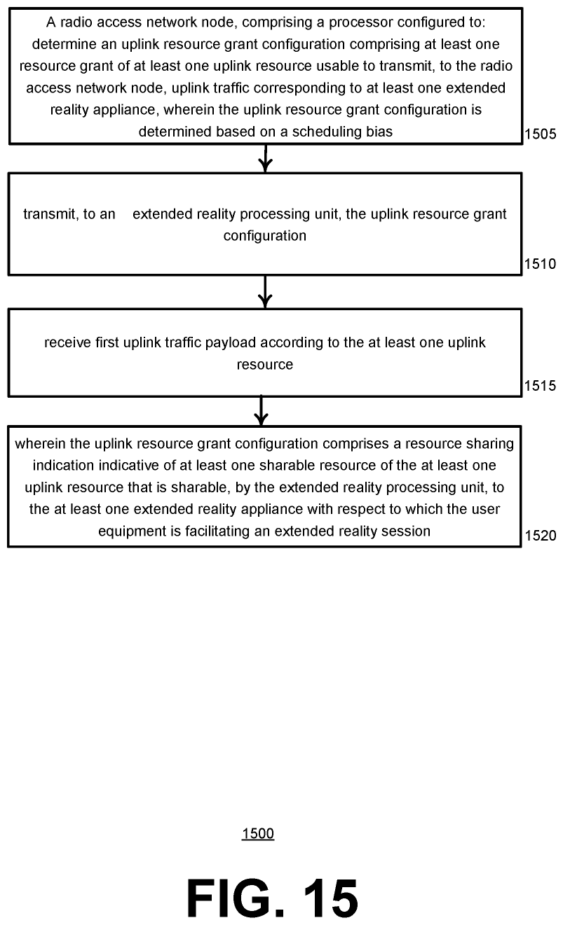

Turning now to FIG. 15, the figure illustrates an example radio access network node 1500, comprising at block 1505 a processor configured to determine an uplink resource grant configuration comprising at least one resource grant of at least one uplink resource usable to transmit, to the radio access network node, uplink traffic corresponding to at least one extended reality appliance, wherein the uplink resource grant configuration is determined based on a scheduling bias; at block 1510 transmit, to an extended reality processing unit, the uplink resource grant configuration; at block 1515 receive first uplink traffic payload according to the at least one uplink resource; and at block 1520 wherein the uplink resource grant configuration comprises a resource sharing indication indicative of at least one sharable resource of the at least one uplink resource that is sharable, by the extended reality processing unit, to the at least one extended reality appliance with respect to which the user equipment is facilitating an extended reality session.

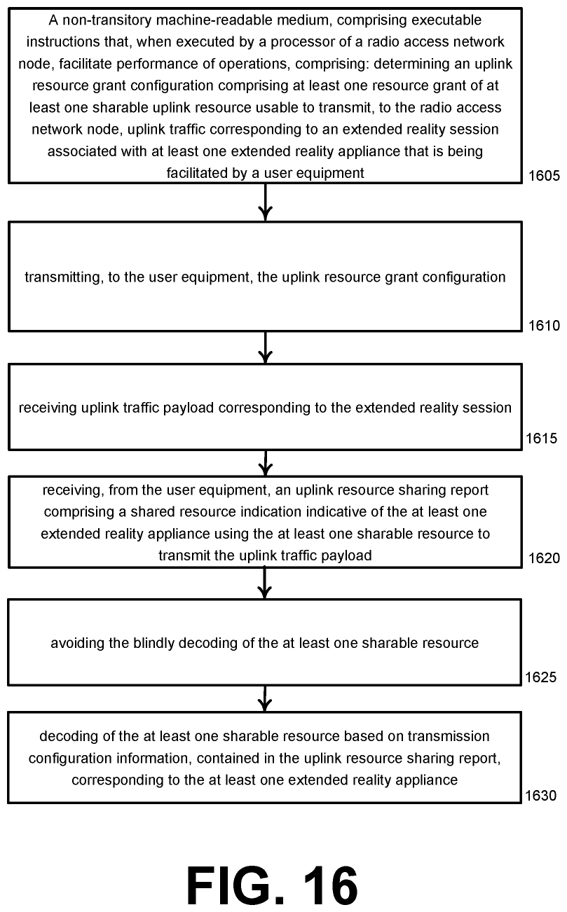

Turning now to FIG. 16, the figure illustrates a non-transitory machine-readable medium 1600 comprising at block 1605 executable instructions that, when executed by a processor of a radio access network node, facilitate performance of operations, comprising determining an uplink resource grant configuration comprising at least one resource grant of at least one sharable uplink resource usable to transmit, to the radio access network node, uplink traffic corresponding to an extended reality session associated with at least one extended reality appliance that is being facilitated by a user equipment; at block 1610 transmitting, to the user equipment, the uplink resource grant configuration; at block 1615 receiving uplink traffic payload corresponding to the extended reality session; at block 1620 receiving, from the user equipment, an uplink resource sharing report comprising a shared resource indication indicative of the at least one extended reality appliance using the at least one sharable resource to transmit the uplink traffic payload; at block 1625 avoiding the blindly decoding of the at least one sharable resource; and at block 1630 decoding of the at least one sharable resource based on transmission configuration information, contained in the uplink resource sharing report, corresponding to the at least one extended reality appliance.

In order to provide additional context for various embodiments described herein, FIG. 17 and the following discussion are intended to provide a brief, general description of a suitable computing environment 1700 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors and may include a cache memory. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

Computer 1702 further includes an internal hard disk drive (HDD) 1714 (e.g., EIDE, SATA), one or more external storage devices 1716 (e.g., a magnetic floppy disk drive (FDD), a memory stick or flash drive reader, a memory card reader, etc.) and an optical disk drive 1720 (e.g., which can read or write from disk 1722, for example a CD-ROM disc, a DVD, a BD, etc.). While the internal HDD 1714 is illustrated as located within the computer 1702, the internal HDD 1714 can also be configured for external use in a suitable chassis (not shown). Additionally, while not shown in environment 1700, a solid-state drive (SSD) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can comprise a security module, such as a trusted processing module (TPM). For instance, with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are examples and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

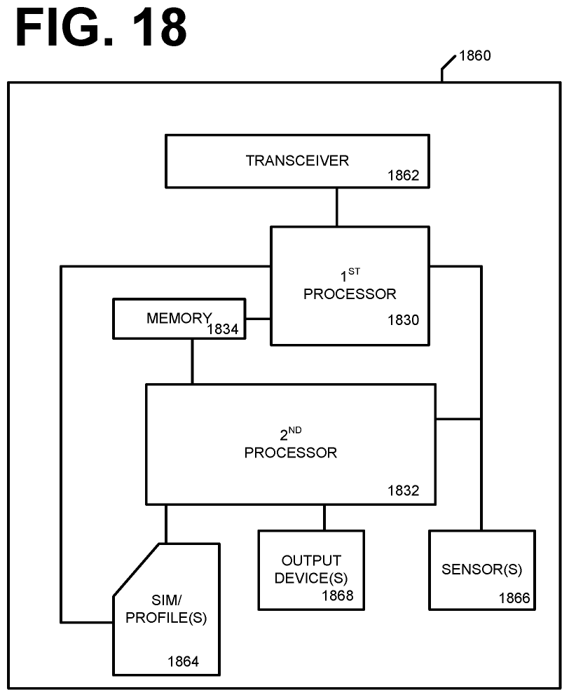

Turning now to FIG. 18, the figure illustrates a block diagram of an example UE 1860. UE 1860 may comprise a smart phone, a wireless tablet, a laptop computer with wireless capability, a wearable device, a machine device that may facilitate vehicle telematics, an intermediate XR processing unit, and the like. UE 1860 may comprise a first processor 1830, a second processor 1832, and a shared memory 1834. UE 1860 may include radio front end circuitry 1862, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1862 may comprise multiple sets of circuitry or may be tunable to accommodate different frequency ranges, different modulations schemes, or different communication protocols, to facilitate long-range wireless links such as links 125, device-to-device links, such as links 135, and short-range wireless links, such as links 137.

Continuing with description of FIG. 18, UE 1860 may also include a SIM 1864, or a SIM profile, which may comprise information stored in a memory (memory 1834 or a separate memory portion), for facilitating wireless communication with RAN 105 or core network 130 shown in FIG. 1. FIG. 18 shows SIM 1864 as a single component in the shape of a conventional SIM card, but it will be appreciated that SIM 1864 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1864 and another device, which may be a component of RAN 105 or core network 130 shown in FIG. 1). A SIM profile 1864 may also comprise identifying information that is unique to the SIM, or SIM profile, such as, for example, an International Mobile Subscriber Identity (“IMSI”) or information that may make up an IMSI.

SIM 1864 is shown coupled to both first processor portion 1830 and second processor portion 1832. Such an implementation may provide an advantage that first processor portion 1830 may not need to request or receive information or data from SIM 1864 that second processor 1832 may request, thus eliminating the use of the first processor acting as a ‘go-between’ when the second processor uses information from the SIM in performing its functions and in executing applications. First processor 1830, which may be a modem processor or baseband processor, is shown smaller than processor second 1832, which may be a more sophisticated application processor than the first processor, to visually indicate the relative levels of sophistication (i.e., processing capability and performance) and corresponding relative levels of operating power consumption levels between the two processor portions. Keeping the second processor portion 1832 asleep/inactive/in a low power state when UE 1860 does not need the second processor for executing applications and processing data related to an application provides an advantage of reducing power consumption when the UE only needs to use the first processor portion 1830 while in listening mode for monitoring routine configured bearer management and mobility management/maintenance procedures, or for monitoring search spaces that the UE has been configured to monitor while the second processor portion remains inactive/asleep.

UE 1860 may also include sensors 1866, such as, for example, temperature sensors, accelerometers, gyroscopes, barometers, moisture sensors, light sensors, and the like that may provide signals to the first processor 1830 or second processor 1832. Output devices 1868 may comprise, for example, one or more visual displays (e.g., computer monitors, VR appliances, and the like), acoustic transducers, such as speakers or microphones, vibration components, and the like. Output devices 1868 may comprise software that interfaces with output devices, for example, visual displays, speakers, microphones, touch sensation devices, smell or taste devices, and the like, that are external to UE 1860.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a radio access network node comprising a processor, receiving, from core network equipment of a core network, a traffic flow information message comprising traffic information corresponding to a traffic flow associated with a user equipment;
based on the traffic information and a scheduling bias, determining, by the radio access network node, an uplink resource grant configuration comprising at least one resource grant of at least one uplink resource usable to transmit, to the radio access network node, uplink traffic corresponding to the traffic flow;
facilitating, by the radio access network node, transmitting, to the user equipment, the uplink resource grant configuration; and
facilitating, by the radio access network node, receiving a first uplink traffic payload corresponding to the traffic flow according to the uplink resource grant configuration.

2. The method of claim 1, wherein the traffic information comprises the scheduling bias.

3. The method of claim 1, further comprising:
based on the traffic information, determining, by the radio access network node, the scheduling bias.

4. The method of claim 3, the method further comprising:
facilitating, by the radio access network node, receiving a second uplink traffic payload corresponding to the traffic flow, wherein the second uplink traffic payload is received before the first uplink traffic payload;
wherein the determining the scheduling bias comprises:
determining a payload segmentation value corresponding to the second uplink traffic payload;
analyzing the payload segmentation value with respect to a payload segmentation criterion, to result in an analyzed payload segmentation value; and
based on the analyzed payload segmentation value satisfying the payload segmentation criterion, increasing a baseline scheduling bias by a scheduling bias adjustment value that corresponds to the analyzed payload segmentation value.

5. The method of claim 4, wherein the determining the payload segmentation value comprises:
determining a segmentation count of at least one packet segment, corresponding to the second uplink traffic payload, associated with violating an uplink latency criterion;
wherein the payload segmentation criterion comprises a latency-violating segment threshold, and wherein the payload segmentation criterion is satisfied by the segmentation count exceeding the latency-violating segment threshold.

6. The method of claim 3, further comprising:
facilitating, by the radio access network node, receiving second uplink traffic payload corresponding to the traffic flow, wherein the second uplink traffic payload is received before the first uplink traffic payload,
wherein the determining the scheduling bias comprises:
determining a payload segmentation value corresponding to the second uplink traffic payload;
analyzing the payload segmentation value with respect to a payload segmentation criterion, to result in an analyzed payload segmentation value; and
based on the analyzed payload segmentation value satisfying the payload segmentation criterion, decreasing a baseline scheduling bias by a scheduling bias adjustment value that corresponds to the analyzed payload segmentation value.

7. The method of claim 6, wherein the payload segmentation criterion is satisfied by a segmentation count, corresponding to the payload segmentation value, being less than a latency-violating segment threshold.

8. The method of claim 1, wherein the uplink resource grant configuration comprises a resource sharing indication indicative of at least one sharable resource of the at least one uplink resource that is sharable, by the user equipment, to at least one extended reality appliance with respect to which the user equipment is facilitating an extended reality uplink traffic flow.

9. The method of claim 8, wherein the uplink resource grant configuration comprises sharable resource information corresponding to the at least one sharable resource.

10. The method of claim 9, wherein the sharable resource information comprises at least one device identifier corresponding to at least one extended reality appliance with respect to which the user equipment is facilitating an extended reality uplink traffic flow.

11. The method of claim 8, wherein the uplink resource grant configuration comprises uplink transmission information corresponding to the at least one extended reality appliance, and wherein the uplink transmission information comprises at least one of: an uplink modulation scheme or an uplink coding scheme.

12. The method of claim 8, further comprising:
facilitating, by the radio access network node, a blind decoding of the at least one sharable resource.

13. The method of claim 8, further comprising:
facilitating, by the radio access network node, receiving, from the user equipment, an uplink resource sharing report comprising a shared resource indication indicative of the at least one of the at least one extended reality appliance using the at least one sharable resource to transmit the extended reality uplink traffic flow;
facilitating, by the radio access network node, avoiding a blind decoding of the at least one sharable resource; and
facilitating, by the radio access network node, a direct decoding of the at least one sharable resource based on transmission configuration information corresponding to the at least one extended reality appliance.

14. A radio access network node, comprising:
a processor configured to:
determine an uplink resource grant configuration comprising at least one resource grant of at least one uplink resource usable to transmit, to the radio access network node, uplink traffic corresponding to at least one extended reality appliance, wherein the uplink resource grant configuration is determined based on a scheduling bias;
transmit, to an extended reality processing unit, the uplink resource grant configuration; and
receive first uplink traffic payload according to the at least one uplink resource.

15. The radio access network node of claim 14, wherein the processor is further configured to:
receive second uplink traffic payload corresponding to the at least one extended reality appliance wherein the second uplink traffic payload is received before the first uplink traffic payload;
determine a payload segmentation value corresponding to the second uplink traffic payload;
analyze the payload segmentation value with respect to a payload segmentation criterion, to result in an analyzed payload segmentation value; and
determine the scheduling bias based on the analyzed payload segmentation value satisfying the payload segmentation criterion.

16. The radio access network node of claim 15, wherein the scheduling bias is determined by increasing a baseline scheduling bias by a scheduling bias adjustment value that corresponds to the analyzed payload segmentation value.

17. The radio access network node of claim 14, wherein the uplink resource grant configuration comprises a resource sharing indication indicative of at least one sharable resource of the at least one uplink resource that is sharable, by the extended reality processing unit, to the at least one extended reality appliance with respect to which the user equipment is facilitating an extended reality session.

18. A non-transitory machine-readable medium, comprising executable instructions that, when executed by a processor of a radio access network node, facilitate performance of operations, comprising:
determining an uplink resource grant configuration comprising at least one resource grant of at least one sharable uplink resource usable to transmit, to the radio access network node, uplink traffic corresponding to an extended reality session associated with at least one extended reality appliance that is being facilitated by a user equipment;
transmitting, to the user equipment, the uplink resource grant configuration; and
receiving uplink traffic payload corresponding to the extended reality session.

19. The non-transitory machine-readable medium of claim 18, the operations further comprising:
blindly decoding the at least one sharable resource.

20. The non-transitory machine-readable medium of claim 18, the operations further comprising:
receiving, from the user equipment, an uplink resource sharing report comprising a shared resource indication indicative of the at least one extended reality appliance using the at least one sharable resource to transmit the uplink traffic payload;
avoiding the blindly decoding of the at least one sharable resource; and
decoding of the at least one sharable resource based on transmission configuration information, contained in the uplink resource sharing report, corresponding to the at least one extended reality appliance.
